(19) United States
(12) Patent Application Publication
(10) Pub. No.: US 2018/0075848 A1
(43) Pub. Date: Mar. 15, 2018

(54) DIALOGUE APPARATUS AND METHOD

(71) Applicant: FUJI XEROX CO., LTD., Tokyo (JP)

(72) Inventors: Takao NAITO, Yokohama-shi (JP); Roshan THAPLIYA, Yokohama-shi (JP)

(73) Assignee: FUJI XEROX CO., LTD., Tokyo (JP)

(21) Appl. No.: 15/439,363

(22) Filed: Feb. 22, 2017

(30) Foreign Application Priority Data
Sep. 15, 2016 (JP) 2016-180318

(51) Int. Cl. G10L 15/22; G10L 15/18

(52) U.S. Cl. CPC G10L 15/22; G10L 25/63; G10L 2015/227; G10L 15/1815

(57) ABSTRACT

A dialogue apparatus includes a memory, an estimation unit, and a dialogue unit. The memory associatively stores a certain topic and a change in an affective state of each user before and after a dialogue on that topic. The estimation unit estimates an affective state of a user using information obtained from a detector that detects a sign that expresses the affective state of the user. The dialogue unit extracts, from the memory, a topic where the affective state obtained by the estimation unit matches or is similar to a pre-dialogue affective state and where a target affective state matches or is similar to a post-dialogue affective state, and has a dialogue on the extracted topic with the user.

### CROSS-REFERENCE TO RELATED APPLICATIONS

This application is based on and claims priority under 35 USC 119 from Japanese Patent Application No. 2016-180318 filed Sep. 15, 2016.

### BACKGROUND

### Technical Field

The present invention relates to a dialogue apparatus and method.

### SUMMARY

According to an aspect of the invention, there is provided a dialogue apparatus including a memory, an estimation unit, and a dialogue unit. The memory associatively stores a certain topic and a change in an affective state of each user before and after a dialogue on that topic. The estimation unit estimates an affective state of a user using information obtained from a detector that detects a sign that expresses the affective state of the user. The dialogue unit extracts, from the memory, a topic where the affective state obtained by the estimation unit matches or is similar to a pre-dialogue affective state and where a target affective state matches or is similar to a post-dialogue affective state, and has a dialogue on the extracted topic with the user.

### BRIEF DESCRIPTION OF THE DRAWINGS

An exemplary embodiment of the present invention will be described in detail based on the following figures, wherein:

FIG. 1 is an explanatory diagram illustrating an example of a dialogue system according to an exemplary embodiment of the present invention;

FIG. 2 is a diagram illustrating the hardware configuration of a dialogue-type robot according to the exemplary embodiment;

FIG. 3 is a functional block diagram of the dialogue-type robot according to the exemplary embodiment;

FIG. 4 is a diagram illustrating an example of a character information database according to the exemplary embodiment;

FIG. 5 is a diagram illustrating an example of a conversation result database according to the exemplary embodiment;

FIG. 6 is a diagram illustrating an example of an affective conversion table according to the exemplary embodiment;

FIG. 7 is a flowchart illustrating the flow of the operation of the dialogue-type robot according to the exemplary embodiment;

FIG. 8 includes diagrams describing the operation of the dialogue-type robot in the case where multiple users are holding a meeting, including: part (A) illustrating the initial state at the beginning of the meeting; part (B) illustrating the state after a certain period of time has elapsed since the beginning of the meeting; and part (C) illustrating the appearance of a dialogue spoken by the dialogue-type robot;

FIG. 9 includes diagrams describing the operation of the dialogue-type robot in the case where multiple users are holding a meeting, including: part (A) illustrating the initial state at the beginning of the meeting; part (B) illustrating the state after a certain period of time has elapsed since the beginning of the meeting; and part (C) illustrating the appearance of a dialogue spoken by the dialogue-type robot; and

FIGS. 10A and 10B are diagrams describing the concept of extracting topics where a change from a user's current affective state to a target affective state is similar to a change from a pre-dialogue affective state to a post-dialogue affective state in the conversation result database, including FIG. 10A illustrating a change from the user's current affective state to a target affective state on the basis of an affective conversion table, and FIG. 10B illustrating a change in the user's affective state before and after a dialogue on certain topics, stored in the conversation result database.

### DETAILED DESCRIPTION

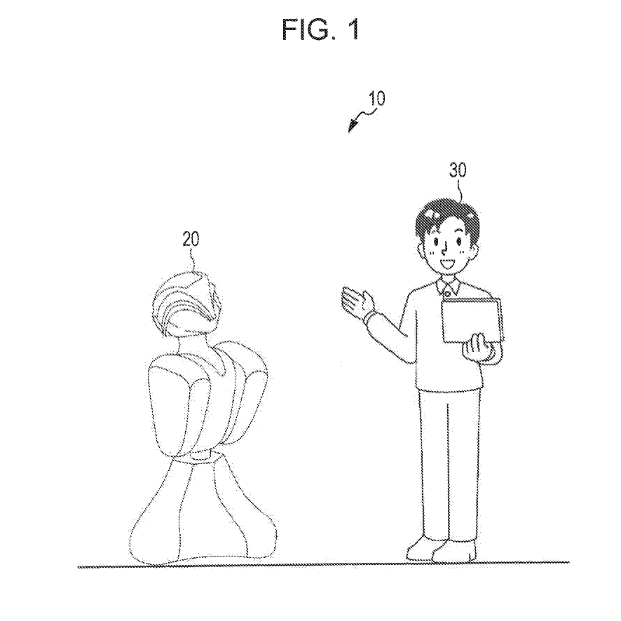

A dialogue system 10 according to an exemplary embodiment of the present invention will be described with reference to FIG. 1. FIG. 1 is an explanatory diagram illustrating an example of the dialogue system 10 according to the exemplary embodiment of the present invention. The dialogue system 10 according to the exemplary embodiment includes a dialogue-type robot 20. The dialogue-type robot 20 has a dialogue with a user 30 in various places such as office and home.

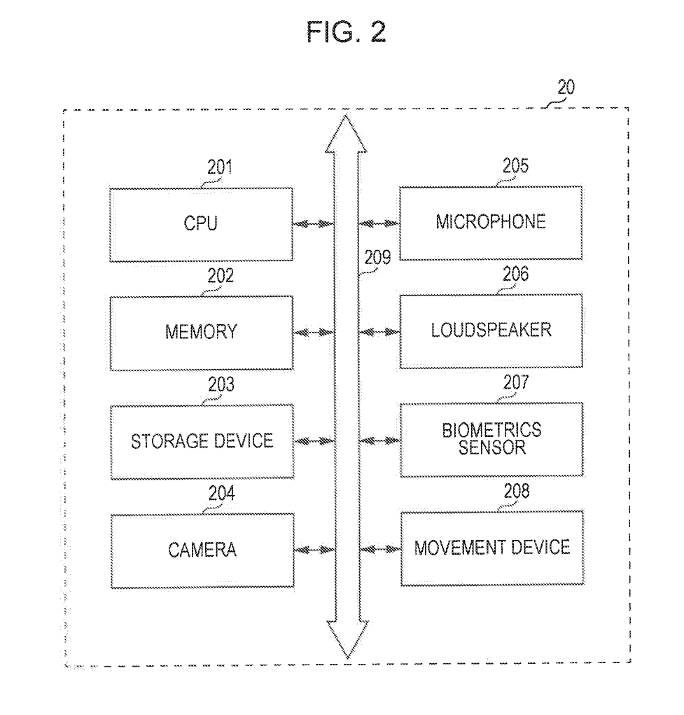

FIG. 2 is a diagram illustrating the hardware configuration of the dialogue-type robot 20. As illustrated in FIG. 2, the dialogue-type robot 20 includes a central processing unit (CPU) 201, a memory 202, a storage device 203 such as a hard disk drive (HDD) or a solid state drive (SSD), a camera 204, a microphone 205, a loudspeaker 206, a biometrics sensor 207, and a movement device 208, which are connected to a control bus 209.

The CPU 201 controls the overall operation of the components of the dialogue-type robot 20 on the basis of a control program stored in the storage device 203. The memory 202 temporarily stores dialogue speeches in a dialogue spoken by the dialogue-type robot 20 with the user 30, dialogue information including the details of the dialogue, a face image of the user, and images of the expression, behavior, and physical state of the user 30 captured by the camera 204. The memory 202 further stores biometrics information, such as the heart rate and the skin resistance, of the user 30, detected by the biometrics sensor 207. The storage device 203 stores a control program for controlling the components of the dialogue-type robot 20. The camera 204 captures changes in the face image, expression, behavior, and physical state of the user 30, and stores these captured changes in the memory 202.

Upon a dialogue with the user, the microphone 205 detects the voice of the user 30, and stores, that is, records, the voice in the memory 202. The memory 202 may alternatively store the details of the dialogue after the details of the voice are analyzed, instead of directly recording the voice. The loudspeaker 206 outputs voice generated by a later-described dialogue controller 212 of the dialogue-type robot 20. The biometrics sensor 207 measures biometrics information, such as the heart rate, skin resistance (skin conductivity), and temperature, of the user 30, and stores the measured data in the memory 202. Sensors according to the exemplary embodiment of the present invention include the camera 204 and the microphone 205 in addition to the biometrics sensor 207, and detect signs that express the affective state of the user 30. The movement device 208 includes wheels and a drive device such as a motor necessary for moving the dialogue-type robot 20 to an arbitrary place, and a current position detector such as a Global Positioning System (GPS) receiver. The camera 204, the microphone 205, and the biometrics sensor 207 function as a detector that detects signs that express the affective state of the user 30.

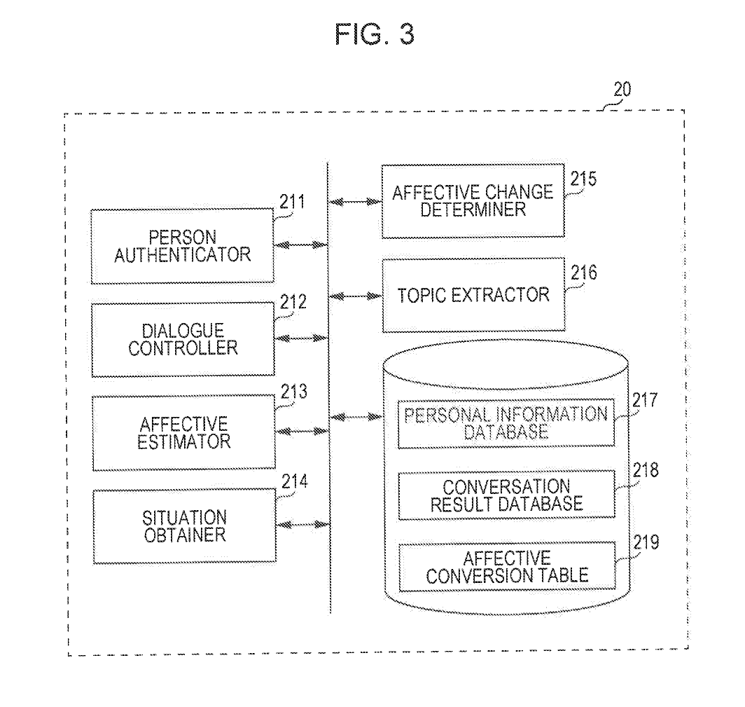

FIG. 3 is a functional block diagram of the dialogue-type robot 20. By executing the control program stored in the storage device 203 with the use of the CPU 201, the dialogue-type robot 20 functions as a person authenticator 211, the dialogue controller 212, an affective estimator 213, a situation obtainer 214, an affective change determiner 215, and a topic extractor 216, as illustrated in FIG. 3. The dialogue-type robot 20 further includes a personal information database 217, a conversation result database 218, and an affective conversion table 219.

The person authenticator 211 analyzes the face image of the user 30, captured by the camera 204 and temporarily stored in the memory 202, and compares the face image with the face image of each user 30 stored in the personal information database 217, thereby identifying who the user 30 is. The person authenticator 211 may identify the user 30 by using another authentication method other than the face authentication method. For example, the following biometrics may be adopted: iris authentication that extracts and uses a partial image of the eyes of the user 30 captured by the camera 204, vein authentication and fingerprint authentication that use biometrics information of the user 30 detected by the biometrics sensor 207, and voiceprint authentication that analyzes and uses the voice of the user 30 captured by the microphone 205. In this case, it is necessary to store, in the personal information database 217, iris pattern information, vein pattern information, fingerprint pattern information, and voiceprint pattern information corresponding to each user 30 in accordance with the authentication method to adopt.

The dialogue controller 212 controls a dialogue of the dialogue-type robot 20 with the user 30. Specifically, the dialogue controller 212 applies control to have a dialogue with the user 30 on a topic extracted by the later-described topic extractor 216. The dialogue controller 212 generates a response message to the user 30 in accordance with the extracted topic, and outputs the response message to the loudspeaker 206. The storage device 203 of the dialogue-type robot 20 stores various conversation patterns and speeches in accordance with various topics (not illustrated), and a dialogue with the user 30 is advanced using these conversation patterns in accordance with the dialogue with the user 30. The dialogue-type robot 20 may include a communication function, and the dialogue controller 212 may obtain appropriate conversation patterns and speeches in accordance with the above-mentioned topic from a server connected to the dialogue-type robot 20 and generate response messages.

The affective estimator 213 estimates the current affective state of the user 30 using information on signs that express the affective state of the user 30, detected by the detector, that is, the camera 204, the microphone 205, and the biometrics sensor 207. Specifically, the affective estimator 213 estimates the affective state of the user 30 on the basis of one or more signs that express the affective state of the user 30, which are configured by at least one or a combination of the behavior of the user 30, the physical state such as the face color, expression, heart rate, temperature, and skin conductivity, the voice tone, the speed of the words (speed of the speech), and details of the dialogue in a dialogue between the user 30 and the dialogue-type robot 20.

For example, a change in the face color is detectable from a change in the proportions of red, green, and blue (RGB) of a face image of the user 30, captured by the camera 204. The affective estimator 213 estimates the affective state of the user 30 such that the user 30 is “happy” from a change in the face color, and how greatly the user 30 opens his/her mouth in the face image, captured by the camera 204. The affective estimator 213 estimates the affective state of the user 30 such that the user is “nervous” from changes in the heart rate, temperature, and skin conductivity of the user 30, detected by the biometrics sensor 207, or the user is “irritated” on the basis of changes in the voice tone and the speed of the words of the user 30.

The situation obtainer 214 obtains a situation where the dialogue-type robot 20 is having a dialogue with the user 30, on the basis of the current position information where the dialogue-type robot 20 and the user 30 are having this dialogue, identified by the current position detector of the movement device 208. This situation may be one of large categories such as “public situation” and “private situation”, or of small categories such as “meeting”, “office”, “rest area”, “home”, and “bar”. The situation obtainer 214 compares the identified current position information with spot information registered in advance in the storage device 203, and obtains a situation where the dialogue-type robot 20 and the user 30 are having the dialogue, on the basis of the spot information corresponding to the current position information.

The affective change determiner 215 refers to the affective conversion table 219 on the basis of the situation where the user 30 and the dialogue-type robot 20 are having the dialogue, obtained by the situation obtainer 214, the normal character (original character) of the user 30, stored in the later-described personal information database 217, and the current affective state of the user 30, estimated by the affective estimator 213, and determines a target affective state different from the current affective state of the user 30. That is, the affective change determiner 215 determines what kind of affective state the dialogue-type robot 20 wants to produce in the user 30. Furthermore, the affective change determiner 215 may make the target affective state different in accordance with the intensity of the current affective state estimated by the affective estimator 213.

The topic extractor 216 extracts, from the conversation result database 218, a topic proven to have changed the affective state of the user 30 from the current affective state to the target affective state, on the basis of the current affective state of the user 30, obtained by the affective estimator 213, the target affective state after the change, determined by the affective change determiner 215, and the situation where the dialogue-type robot 20 and the user 30 are having the dialogue. Specifically, the topic extractor 216 extracts, from the conversation result database 218, a topic where the current affective state of the user 30, obtained by the affective estimator 213, matches a pre-dialogue affective state in the conversation result database 218, and where the target affective state matches a post-dialogue affective state in the conversation result database 218.

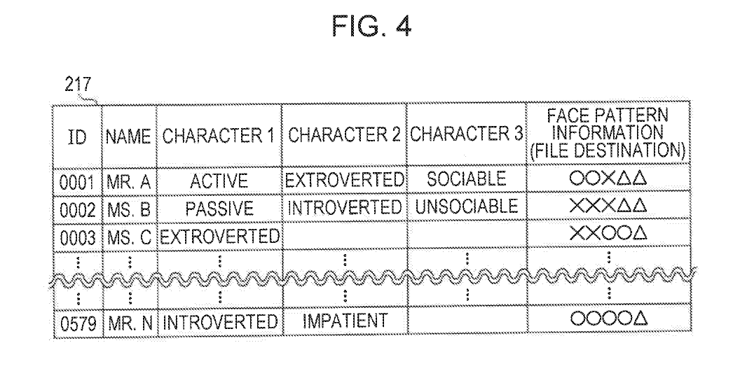

The personal information database 217 stores information on the face image and the normal character of each user 30 in association with each other. FIG. 4 is a diagram illustrating an example of the personal information database 217. The personal information database 217 stores the ID of each user 30, character 1, character 2, character 3, and information on the face image in association with each other. For example, character 1 “active”, character 2 “extroverted”, and character 3 “sociable” are associated with the ID “Mr. A”. The information on the face image may be a data set indicating the positions of elements constituting a face, such as the eyes and the nose, or may be data indicating the destination where the face image data is saved.

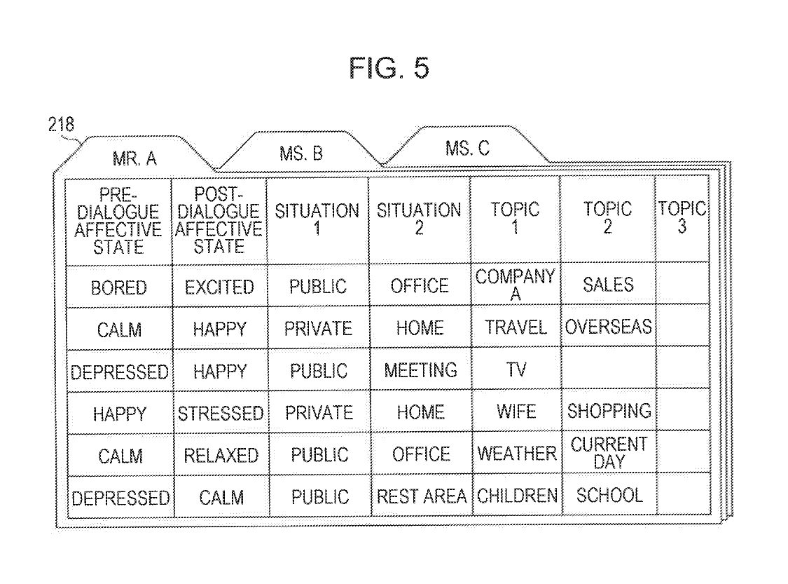

The conversation result database 218 is a database that associatively stores, in each certain situation, a certain topic and a change in the affective state of each user 30 before and after a dialogue on that topic. In other words, the conversation result database 218 accumulates the record of how each user's affective state has changed when having a dialogue on what topic in what situation. FIG. 5 illustrates an example of the conversation result database 218. As illustrated in FIG. 5, a pre-dialogue affective state, a post-dialogue affective state, situation 1, situation 2, topic 1, topic 2, and topic 3 are associated with each user 30. For example, in FIG. 5, the first affective state “bored”, the affective state after the change “excited”, situation 1 “public”, situation 2 “office”, topic 1 “company A”, and topic 2 “sales” are stored in association with “Mr. A”. This specifically means that, when Mr. A had a dialogue on a topic about the sales of company A in a public place, specifically in his office, he was bored, which is the pre-dialogue affective state, but, as a result of the dialogue, his affective changed and he became excited.

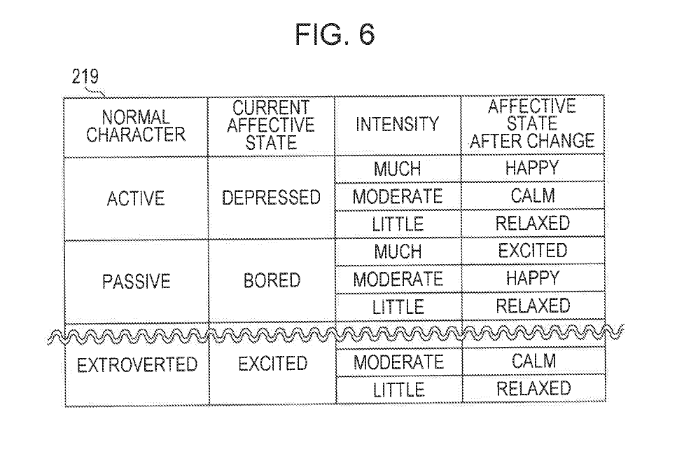

The affective conversion table 219 associatively stores, for each user 30, the normal character, the current affective state, the intensity of the current affective state, and a target affective state different from the current affective state. FIG. 6 is an example of the affective conversion table 219. In FIG. 6, the target affective state after the change “happy” for the intensity of the current affective state “much”, the target affective state after the change “calm” for the intensity of the current affective state “moderate”, and the target affective state after the change “relaxed” for the intensity of the current affective state “little” are stored in association with the normal character “active” and the current affective state “depressed”.

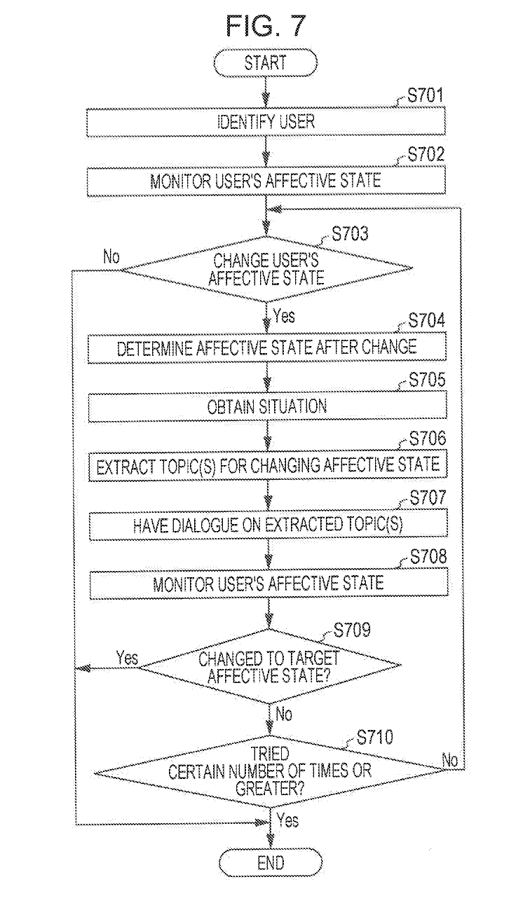

Next, the flow of the operation of the dialogue-type robot 20 according to the exemplary embodiment will be described with reference to FIG. 7. FIG. 7 is a flowchart illustrating the flow of the operation of the dialogue-type robot 20. When the dialogue-type robot 20 starts a dialogue with the user 30, the person authenticator 211 refers to the personal information database 217 on the basis of the face image of the user 30, captured by the camera 204, and identifies who the user 30, the dialogue partner, is. As has been described previously, the person authenticator 211 may identify who the user 30, the dialogue partner, is using a method such as iris authentication, vein authentication, fingerprint authentication, or voiceprint authentication.

Next in step S702, the affective estimator 213 estimates the affective state of the user 30 using information obtained by a detector that detects signs that express the affective state of the user 30. Specifically, the affective estimator 213 estimates the current affective state of the user 30 and its intensity on the basis of the behavior, face color, and expression of the user 30, captured by the camera 204, the physical states such as the heart rate, temperature, and skin conductivity of the user 30, detected by the biometrics sensor 207, and the voice tone, the speed of the words, and details of the dialogue of the user 30, detected by the microphone 205.

Next in step S703, the affective change determiner 215 determines whether to change the affective state of the user 30. Specifically, the affective change determiner 215 refers whether an affective conversion pattern identified by a combination of the normal character of the user 30, stored in the personal information database 217, and the current affective state of the user 30, estimated in step S702 described above, is included in the affective conversion table 219, and, if there is such an affective conversion pattern, the affective change determiner 215 determines to change the affective state of the user 30, and proceeds to step S704. If there is no such affective conversion pattern, the affective change determiner 215 determines not to change the affective state, and the operation ends.

For example, it is assumed that the user 30 identified in step S701 described above is “Mr. A”, and the current affective state of “Mr. A” estimated in step S702 described above is “depressed”, and its intensity is “moderate”. In that case, the affective change determiner 215 refers to the personal information database 217, identifies that the normal character of “Mr. A” is “active”, and determines whether there is an affective conversion pattern corresponding to the normal character (“active”) of “Mr. A” and the current affective state (“depressed”) of “Mr. A” identified in step S702 described above. Because there is a conversion pattern that includes the normal character “active” and the current affective state “depressed” in the affective conversion table 219, the affective change determiner 215 determines to change the feeing of “Mr. A”, and proceeds to step S704.

In step S704, the affective change determiner 215 refers to the affective conversion table 219, and determines a target affective state, different from the current affective state, corresponding to the normal character of the user 30, the current affective state of the user 30, and its intensity. For example, when the user 30 is “Mr. A”, the affective change determiner 215 refers to the affective conversion table 219 and, because the target affective state after the change in the case where the intensity of the current affective state “depressed” is “moderate” is “calm”, the affective change determiner 215 determines “calm” as the affective state.

In step S705, the situation obtainer 214 identifies a situation where the user 30 and the dialogue-type robot 20 are having the dialogue, on the basis of the current position information detected by the current position detector of the movement device 208. Specifically, the situation obtainer 214 identifies to which of the large categories such as “public situation” and “private situation”, and further of the small categories such as “meeting”, “office”, “rest area”, “home”, and “bar” the situation where the user 30 and the dialogue-type robot 20 are having the dialogue correspond.

In step S706, the topic extractor 216 extracts, from the conversation result database 218, a topic where the affective state of the user 30, estimated by the affective estimator 213, matches a pre-dialogue affective state in the conversation result database 218, and where the target affective state, determined by the affective change determiner 215, matches a post-dialogue affective state in the conversation result database 218, on the basis of the situation where the dialogue is taking place. Specifically, the topic extractor 216 extracts a topic where the current affective state of the user 30 matches a “pre-dialogue affective state” in the conversation result database 218 and where the target affective state after the change matches a “affective state after the change” in the conversation result database 218. For example, it is assumed that, in the above-mentioned example, a situation where “Mr. A” is having a dialogue with the dialogue-type robot 20 is a “public” place and that place is a “rest area”. In this case, reference to the conversation result database 218 clarifies that there has been an actual conversation where, in the “public” situation of the “rest area”, when a dialogue took place on the topics “children” and “school”, the pre-dialogue affective state “depressed” changed to the post-dialogue affective state “calm”. Thus, the topic extractor 216 extracts, from the conversation result database 218, the topics “children” and “school” in order to change the mood of the user 30.

In step S707, the dialogue controller 212 generates dialogue details for having a dialogue with the user 30 on the basis of the extracted topics and outputs the dialogue voice using the loudspeaker 206, thereby having a dialogue with the user 30. In the above-described example, the dialogue controller 212 applies control to have a dialogue with “Mr. A”, who is the user 30, on the topics “children” and “school” extracted in step S706. Next in step S708, the affective estimator 213 monitors the affective state of the user 30, who is the dialogue partner, and estimates the affective state of the user 30 at the time of the dialogue or after the dialogue using the above-mentioned topics.

In step S709, the affective change determiner 215 determines whether the user 30 has changed his affective state to the target affective state, on the basis of the affective state of the user 30 estimated by the affective estimator 213. If the user 30 has changed his affective state to the target affective state, the operation ends. If it is determined that the user 30 has not changed his affective state to the target affective state, the operation proceeds to step S710. Specifically, the affective change determiner 215 determines whether “Mr. A”, who is the user 30, has changed his affective state to “calm”, which is the target affective state, when he had a dialogue with the dialogue-type robot 20 on the topics “children” and “school”. If “Mr. A” has become “calm”, the operation ends. If it is determined that “Mr. A” has not become “calm” yet, the operation proceeds to step S710.

In step S710, the affective change determiner 215 determines the number of times the above-described processing from step S703 to step S709 is performed, that is, the number of dialogues with the user 30 using the topics for changing the affective state of the user 30. If it is determined that the number of times is less than a certain number of times, the operation returns to step S703, repeats the processing from step S703 to step S709, and retries to change the affective state of the user 30. If it is determined in step S710 that the number of dialogues on the topics for changing the affective state of the user 30 is already the certain number, the operation ends.

The operation of the dialogue-type robot 20 for having a dialogue(s) with the user 30 according to the exemplary embodiment has been described as above. In the exemplary embodiment, the case where there is only one user 30 with which the dialogue-type robot 20 has a dialogue has been described. However, the number of dialogue partners of the dialogue-type robot 20 according to the exemplary embodiment of the present invention is not limited to one, and multiple users 30 may serve as dialogue partners. For example, when multiple users 30 gather at one place in order to hold a meeting or the like, the affective change determiner 215 of the dialogue-type robot 20 determines a user 30 whose affective state is to-be changed and a target affective state different from the current affective state of that user 30 of interest, extracts a topic(s) for changing the affective state of that user 30, and has a dialogue(s) with the user 30 on that topic(s) to change the affective state of the user 30.

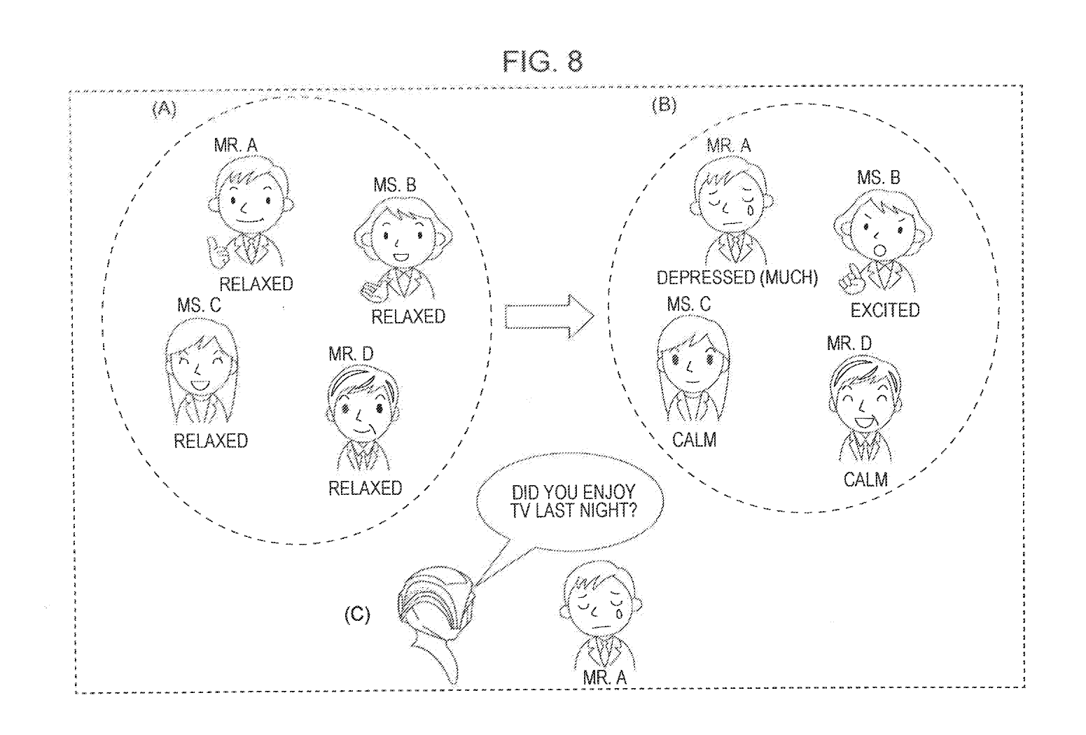

FIG. 8 illustrates how the four users “M. A”, “Ms. B”, “Ms. C”, and “Mr. D” are holding a meeting. As illustrated in part (A) of FIG. 8, the four users are “relaxed” at the beginning of the meeting. Thereafter, as illustrated in part (B) of FIG. 8, as the meeting progresses, the affective states of the four users participating in the meeting change. Specifically, as illustrated in part (B) of FIG. 8, the affective state of “Mr. A” changes to a state of “depressed” and “much”, the affective state of “Ms. B” changes to “excited”, and the affective states of “Ms. C” and “Mr. D” both change to “clam”. At this time, the affective change determiner 215 refers to the affective conversion table 219 to determine, among the four users participating in the meeting, whose affective state is to be changed and to what affective state that user's affective state is to be changed. When there are multiple users, the affective conversion table 219 includes a priority determination table (not illustrated) to which the affective change determiner 215 refers when determining whose affective state is to be changed.

For example, it is assumed that, in the affective conversion table 219, the affective state of a person whose normal character is “active” and current affective state is “depressed” and “much” is to be changed in preference to the others. In this case, the affective change determiner 215 refers to the affective conversion table 219, gives priority to the affective state of “Mr. A”, and determines to change the affective state from “depressed” and “much” to “happy”. The topic extractor 216 extracts, from the conversation result database 218, a topic where the current affective state of the user 30 whose affective state is determined to be changed matches a pre-dialogue affective state in the conversation result database 218, and where the target affective state after the change matches a post-dialogue affective state in the conversation result database 218, on the basis of a context where the dialogue is taking place. In reference to the conversation result database 218 illustrated in FIG. 5, when “Mr. A” participated in a “meeting” in a “public” place, there has been an actual conversation where his affective changed from the pre-dialogue affective state “depressed” to the post-dialogue affective state “happy” when having a dialogue on the topic “television (TV)”. Thus, the topic extractor 216 extracts the topic “TV” for changing the affective state of “Mr. A” from the conversation result database 218, and the dialogue controller 212 applies control to have a dialogue on the topic “TV”. For example, the dialogue controller 212 applies control to cause the dialogue-type robot 20 to ask “Mr. A” a question like “Did you enjoy TV last night?”, as illustrated in part (C) of FIG. 8.

After trying to change the affective state of “Mr. A”, the dialogue-type robot 20 again refers to the affective conversion table 219 to determine whether there is a user 30 whose affective state is to be changed next among the other users 30. If there is such a user 30, the dialogue-type robot 20 performs processing that is the same as or similar to the above-described processing for “Mr. A”.

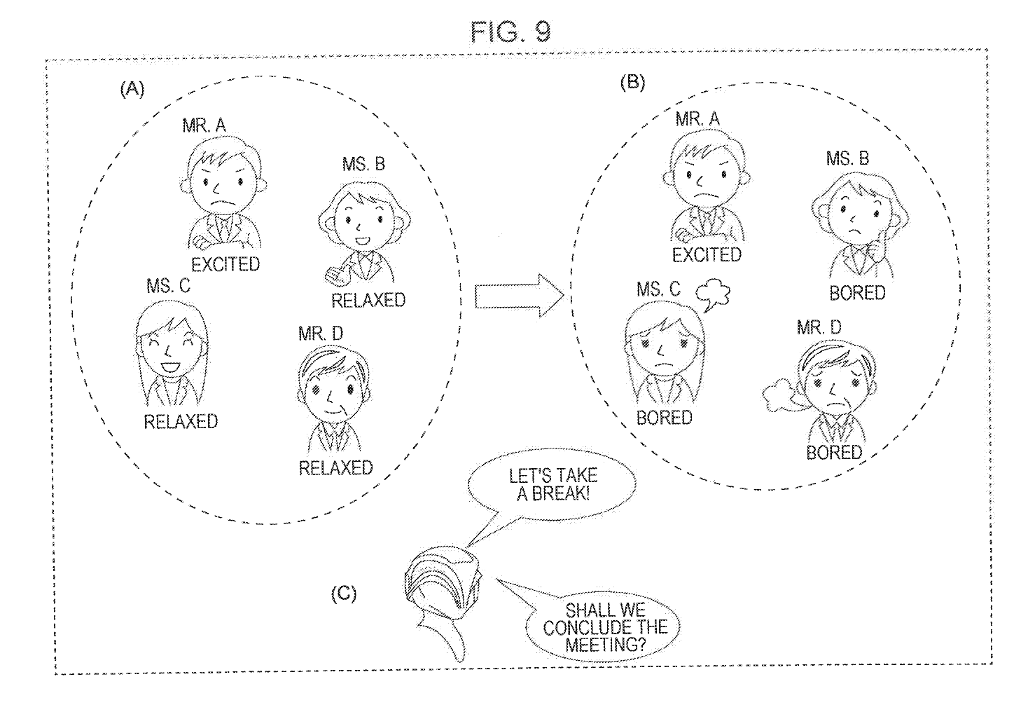

In the example illustrated in FIG. 8, the method of taking the individual affective states of the four users 30 into consideration and individually changing the affective states has been described. However, the exemplary embodiment is not limited to this method, and the dialogue-type robot 20 may take the overall affective state of users 30 who are in the same place into consideration and apply control to change the overall affective state of these multiple users 30. For example, FIG. 9 illustrates how the four users “M. A”, “Ms. B”, “Ms. C”, and “Mr. D” are holding a meeting. As illustrated in part (A) of FIG. 9, at the beginning of the meeting, “Mr. A”, whose original character is “extroverted”, is “excited”; and the other three users, namely, “Ms. B”, whose original character is “extroverted”, “Ms. C”, whose original character is “introverted”, and “Mr. D”, whose original character is “introverted”, are “relaxed”. However, as the meeting progresses, it is assumed that only “Mr. A” is talking, and “Ms. B”, “Ms. C”, and “Mr. D” are all “bored”, as illustrated in part (B) of FIG. 9.

In this case, the affective estimator 213 estimates the overall affective state or the average affective state of the users 30 who are there, and the affective change determiner 215 determines whether to change the overall affective state, and, if it is determined to change the overall affective state, to what affective state the overall affective state is to be changed. The topic extractor 216 extracts, from the conversation result database 218, a topic where the overall affective state of the users 30 matches a pre-dialogue affective state in the conversation result database 218, and where the target affective state after changing the overall affective state of the users 30 matches a post-dialogue affective state in the conversation result database 218, and the dialogue controller 212 has a dialogue with the multiple users 30 on the extracted topic to change the overall atmosphere. For example, as illustrated in part (C) of FIG. 9, if almost all the users 30 are bored at the meeting, the dialogue-type robot 20 make a proposal to the multiple users 30 by saying “Let's take a break!” or “Shall we conclude the meeting?”.

Although the case where the dialogue-type robot 20 includes the personal information database 217, the conversation result database 218, and the affective conversion table 219 has been described as above, the exemplary embodiment of the present invention is not limited to this case, and these components may be arranged in a server connected through a communication line to the dialogue-type robot 20. The biometrics sensor 207 may be located not only in the dialogue-type robot 20, but also in other places, such as in an office. In this case, a motion sensor located on the ceiling or wall of the office may be adopted as the biometrics sensor 207.

Although the appearance of the dialogue-type robot 20 is illustrated in a shape that imitates a person in the exemplary embodiment, the appearance need not be in the shape of a person as long as the dialogue-type robot 20 is a device that is capable of having a dialogue with the user 30.

Although an example where the topic extractor 216 extracts, from the conversation result database 218, a topic where the current affective state of the user 30, obtained by the affective estimator 213, matches a pre-dialogue affective state in the conversation result database 218, and where the target affective state, determined by the affective change determiner 215, matches a post-dialogue affective state in the conversation result database 218 has been described in the above-described embodiment, the exemplary embodiment of the present invention is not limited to the above-described example in which a topic where the affective states “match” is extracted, and a topic where the affective states are “similar” may be extracted.

For example, the topic extractor 216 may extract, from the conversation result database 218, a topic where the current affective state of the user 30 matches a pre-dialogue affective state in the conversation result database 218, and where the target affective state is similar to a post-dialogue affective state in the conversation result database 218. Alternatively, the topic extractor 216 may extract, from the conversation result database 218, a topic where the current affective state of the user 30 is similar to a pre-dialogue affective state in the conversation result database 218, and where the target affective state matches a post-dialogue affective state in the conversation result database 218. Alternatively, the topic extractor 216 may extract, from the conversation result database 218, a topic where the current affective state of the user 30 is similar to a pre-dialogue affective state in the conversation result database 218, and where the target affective state is similar to a post-dialogue affective state in the conversation result database 218.

In the above-described exemplary embodiment, the case has been described in which the topic extractor 216 extracts a topic where the current affective state of the user 30 matches or is similar to a pre-dialogue affective state in the conversation result database 218, and where the target affective state matches or is similar to a post-dialogue affective state in the conversation result database 218. However, the exemplary embodiment of the present invention is not limited to this case, and, for example, a topic where a change from the current affective state to the target affective state of the user 30 matches or is similar to a change from a pre-dialogue affective state to a post-dialogue affective state in the conversation result database 218 may be extracted from the conversation result database 218.

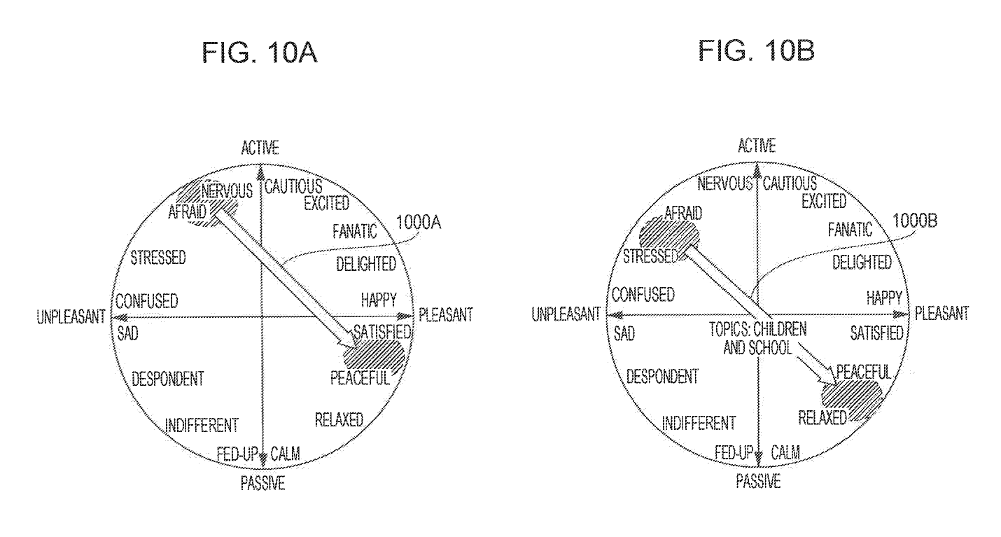

FIGS. 10A and 10B are diagrams describing the concept of extracting topics where a change from the current affective state to the target affective state of the user 30 is similar to a change from a pre-dialogue affective state to a post-dialogue affective state in the conversation result database 218. FIG. 10A illustrates a change from the current affective state to the target affective state of the user 30 on the basis of the affective conversion table 219, and FIG. 10B illustrates a change in the affective state of the user 30 before and after a dialogue on certain topics, stored in the conversation result database 218. As illustrated in FIG. 10A, the current affective state of the user 30, estimated by the affective estimator 213, and the target affective state after the change, determined by the affective change determiner 215, are projected to a two-dimensional affective map. The two-dimensional affective map has “pleasant” and “unpleasant” on the horizontal axis and “active” and “passive” on the vertical axis. Various affective states (such as “happy” and “sad”) corresponding to values on the horizontal axis and the vertical axis are assigned.

If the current affective state of the user 30 is “nervous” and “afraid” and the target affective state is “satisfied” and “peaceful”, a change in the affective state that the user 30 is requested to have is expressed by a vector 1000A in FIG. 10A. The topic extractor 216 refers to the conversation result database 218 and extracts, from the conversation result database 218, a topic where a change in the affective state before and after a dialogue, stored in the conversation result database 218, matches or is similar to a change in the affective state expressed by the vector 1000A. For example, the conversation result database 218 stores an actual conversation where, as illustrated in FIG. 10B, the pre-dialogue affective states “afraid” and “stressed” of the user 30 change to the post-dialogue affective states “peaceful” and “relaxed” when the user 30 has a dialogue on the topics “children” and “school”. This change in the affective state in this case is expressed by a vector 1000B.

A change in the affective state from the current affective state to the target affective state (vector 1000A) matches a change in the affective state before and after a dialogue on the topics “children” and “school” (vector 1000B), stored in the conversation result database 218, in the direction and length though differs in the start point and the end point. Thus, the topic extractor 216 extracts the topics “children” and “school” in order to change the mood of the user 30. Not only in the case where a vector that expresses a change from the current affective state to the target affective state matches a vector that expresses a change in the affective state before and after a dialogue on a certain topic, stored in the conversation result database 218, but also in the case where the direction and length are within predetermined thresholds or in the case where the deviations of the direction, length, and barycenter are within predetermined thresholds, the topic extractor 216 may regard that the vectors (such as 1000A and 1000B) are similar, and may extract a topic that produces an affective change expressed by one of the vectors (1000B).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A dialogue apparatus comprising:
a memory that stores affective states of users before and after a dialogue on a topic;
an estimation unit that estimates an affective state of a user; and
a dialogue unit that extracts, from the memory, a topic where the estimated affective state matches or is like a pre-dialogue affective state and where a target affective state matches or is like a post-dialogue affective state, and has a dialogue on the extracted topic with the user.

2. A dialogue apparatus comprising:
a memory that associatively stores a certain topic and a change in an affective state of each user before and after a dialogue on that topic;
an estimation unit that estimates an affective state of a user using information obtained from a detector that detects a sign that expresses the affective state of the user; and
a dialogue unit that extracts, from the memory, a topic where a change from the affective state obtained by the estimation unit to a target affective state matches or is similar to a change in the feeing before and after a dialogue in the memory, and has a dialogue on the extracted topic with the user.

3. The dialogue apparatus according to claim 1, further comprising:
an obtaining unit that obtains a situation where the dialogue apparatus and the user have a dialogue, wherein
the memory associatively stores, for each situation obtained by the obtaining unit, a topic and a change in the affective state of the user before and after a dialogue on that topic, and
in a situation corresponding to the situation obtained by the obtaining unit, the extraction unit extracts, from the memory, a topic where the affective state obtained by the estimation unit matches or is similar to a pre-dialogue affective state and where the target affective state matches or is similar to a post-dialogue affective state.

4. The dialogue apparatus according to claim 3, wherein the obtaining unit estimates the situation on the basis of a position where the dialogue apparatus and the user have a dialogue.

5. The dialogue apparatus according to claim 1, wherein the extraction unit determines the target affective state in accordance with intensity of a current affective state of the user, estimated by the estimation unit, and extracts the topic.

6. The dialogue apparatus according to claim 1, wherein:
the memory further stores a character of the user, and
the extraction unit determines the target affective state in accordance with the character of the user, stored in the memory, and extracts the topic.

7. The dialogue apparatus according to claim 1, wherein, when there is a plurality of users, the extraction unit determines a user of interest whose affective state is to be changed and a target affective state different from a current affective state of the user of interest, and extracts the topic.

8. A dialogue method comprising:
estimating an affective state of a user using information obtained from a detector that detects a sign that expresses the affective state of the user; and
extracting, from a memory that associatively stores a certain topic and a change in an affective state of each user before and after a dialogue on that topic, a topic where the estimated affective state matches or is similar to a pre-dialogue affective state and where a target affective state matches or is similar to a post-dialogue affective state, and having a dialogue on the extracted topic with the user.
